(19) United States
(12) Patent Application Publication
(10) Pub. No.: US 2008/0170575 A1
(43) Pub. Date: Jul. 17, 2008

(54) SYSTEM AND METHOD FOR DISTRIBUTED INTELLIGENT-ASSISTANT CONTROL OF PREDICTIVE DIGITAL INFORMATION DISTRIBUTION

(76) Inventor: Andrew J. Czuchry, Auburn, GA (US)

Correspondence Address: W. EDWARD RAMAGE, COMMERCE CENTER SUITE 1000, 211 COMMERCE ST, NASHVILLE, TN, 37201, US

(21) Appl. No.: 12/013,270

(22) Filed: Jan. 11, 2008

Related U.S. Application Data
(60) Provisional application No. 60/884,696, filed on Jan. 12, 2007.

(51) Int. Cl. H04L 12/56

(52) U.S. Cl. 370/395.1; 370/389

(57) ABSTRACT

An information-based system for controlling the display of digital content dependent upon a state-based controller comprised of status and intelligent-assistant logic. In an exemplary embodiment, the system programmatically integrates distributed automata theory processing for alternative, yet interrelated, states of control within a digital content display system. The state-based system provides a number of functional features, including but not limited to, distributed intelligent-assistant control for content packetization and encapsulation; intelligent state-based caching for predictive content distribution; programmatic control of state-based automata for intelligent caching modules; flowthrough administrative control; and multiphasic user experience presentation modules. The net result of programmatic control of state-based automata for intelligent caching modules, embedded within distributed intelligent-assistant control for content packetization and encapsulation of predictive information distribution, is a state-based intelligent-assistant system for multiphasic user experience of digital information display.

This application claims benefit of, and priority to, U.S. Provisional Patent Application No. 60/884,696, filed Jan. 12, 2007, entitled “A SYSTEM FOR DISTRIBUTED INTELLIGENT-ASSISTANT CONTROL OF PREDICTIVE DIGITAL INFORMATION DISTRIBUTION.” The complete specification, drawings, attachments and disclosure of U.S. Provisional Patent Application No. 60/884,696 are incorporated herein by specific reference.

### TECHNICAL FIELD

The present invention relates to information management, information distribution, and digital information display. More particularly, the present invention relates to a control system based on a state-based, intelligent-assistant paradigm for predictive packetization, encapsulation, distribution and display of digital content.

### BACKGROUND OF THE INVENTION

The distribution and display of digital content requires several vital components to maintain an integrated communication model wherein processing is dependent upon the state of either the content itself or the distribution of that content, or both. Key among these components is distributed, predictive state-based processing and control. Many software and hardware systems address the broadcast distribution and playback processing components, but there is a general lack in the field of an integrated intelligent-assistance, predictive state-based mechanism that varies the processing control based upon the current state of the content display process, particularly in distributed asynchronous processing.

There is a need to bridge the system gap that exists between the functionality of multicast streaming solutions and functionality of peer-to-peer file sharing. Multicast streaming architecture may provide distribution efficiencies but generally imposes concurrency constraints. Peer-to-peer file sharing architectures provide for asynchronous file access yet their process models may expose client security vulnerabilities and/or may impact client bandwidth as it services peer client requests. There exists, therefore, the need for a solution that bridges the system gap and provides for service efficiencies (including, but not limited to, bandwidth and latency efficiencies) as well as closed loop security services for individual “smart client” connections. Accordingly, there is a need in the art for an intelligent-assistant predictive state-based system for controlling content distribution and display in digital content communication channels. It is to such that the present invention is directed.

### SUMMARY OF THE INVENTION

This invention is directed to an information-based system for controlling the display of digital content dependent upon a state-based status and intelligent-assistant logic of the information flow controller. In one exemplary embodiment, the system programmatically integrates distributed automata theory processing for alternative, yet interrelated, states of control within a digital content display system.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a system overview presenting a system architecture embodying five key functions in accordance with an embodiment of the present invention.

FIG. 2 is a detailed schematic illustration of a state-based intelligent-assistant system for digital content distribution and digital content display control technology in accordance with an embodiment of the present invention.

### DETAILED DESCRIPTION OF EXEMPLARY EMBODIMENTS

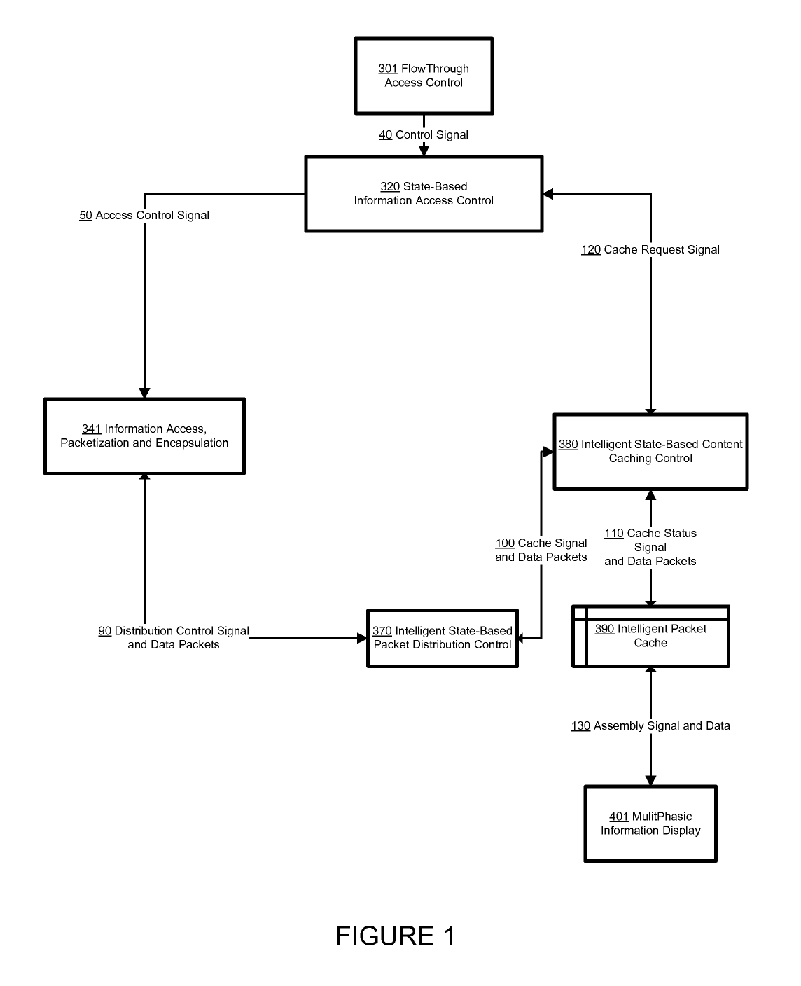

FIG. 1 shows an exemplary embodiment of a system for intelligent-assistant control of predictive digital information distribution comprising five (5) key functions: (1) intelligent-assistant control of information distribution; (2) state-based control; (3) intelligent caching; (4) multiPhasic user experience (multiphasic information display); and (5) predictive distribution. The functional processing embodied in this embodiment of the system provides a “smart client” architecture, while simultaneously enabling “transmission efficiencies” such as “bandwidth multiplexing” and “latency reduction” via distributed and/or local intelligent caching.

In the exemplary embodiment shown, the intelligent-assistant control of information distribution is initiated via the FlowThrough Access Control process 301. State-based control is initiated via the Control Signal 40 that feeds from the FlowThrough Access Control process 301 to the State-Based Information Access Control process 320. The intelligent caching process flows from the State-Based Information Access Control process 320 and has multiple components. The intelligent caching process is programmatically managed through a state-based access and distribution control loop.

Intelligent caching is initiated by the Access Control Signal 50 as it feeds the Information Access, Packetization and Encapsulation Module 341. Subsequently, the Distribution Control Signal and Data Packets 90 feed the Intelligent State-Based Packet Distribution Control module 370. Control is then transferred to the Intelligent State-Based Content Caching Control 380 process via the Cache Signal and Data Packets 100. The state-based access and distribution control loop is completed via the Cache Request Signal 120. In an asynchronous integrated process model controlled by the Intelligent State-Based Content Caching Control 380, the information data packets are cached in the Intelligent Packet Cache 390 feed by the Cache Status Signal and Data Packets 110. This Intelligent Packet Cache 390 could embody multiple distributed storage locations in various embodiments.

The MultiPhasic user experience is comprised of the assembly and display of the cached packets. The Intelligent Packet Cache 390 fulfills the control and data feeds of the MultiPhasic Information Display 401 via the Assembly Signal and Data feed 130.

The functional processing of the collective architectural grouping (370, 380, 390, 401, 100, 110, 130) provides a “smart client” architecture. The functional processing of the collective architectural grouping (320, 341, 120, 50, 90) enables “transmission efficiencies” such as “bandwidth multiplexing” and “latency reduction” via distributed and/or local intelligent caching. The complete system provides predictive distribution for multiphasic user experiences via intelligent-assistant control through state-based control of intelligent caching processes.

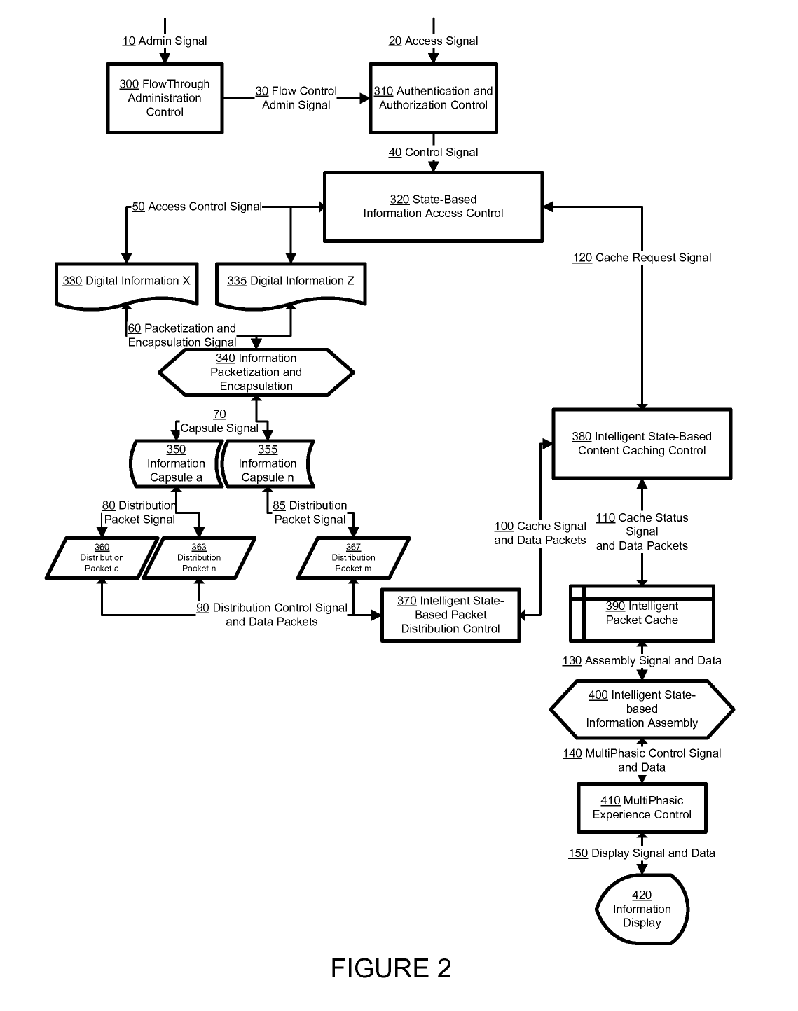

FIG. 2 shows an exemplary embodiment of a state-based intelligent-assistant system for digital content distribution and digital content display control technology. It comprises control signals (10, 20, 30, 40, 50, 60, 70, 80, 85), control modules (300, 310), state-based processing modules (320, 370, 380), digital information (330, 335), packetization and encapsulation of distribution packets (340, 350, 355, 360, 363, 367), state-based data and control flow (90, 100, 110, 120, 130, 140, 150), state-based intelligent caching modules (370, 380, 390), display preparation and presentation modules (400, 410, 420). The intelligence assistance logic is embedded programmatically within the state-based automata of the state-based processing and intelligent caching modules.

The predictive distribution of digital information is triggered through an access request via the Access Signal 20. The Access request is filtered via the Administrative flow through process comprised of the Admin Signal 10 feeding into the FlowThrough Administrative Control Module 300 and producing the Flow Control Admin Signal 30. The Access Signal 20 and Flow Control Admin Signal 30 are processed in the Authentication and Authorization Control 310 to produce the Control Signal 40 that initiates the state-based intelligent-caching of predictive digital information distribution. The state-based process is initiated in the State-Based Information Access Module 320 which produces an Access Control Signal 50 that is fed to the Digital Information 330, 335. While any number of Digital Information elements may be supported, only two are depicted in this exemplary embodiment. Examples of Digital Information include, but are not limited to, video content, audio content, and digital documents.

A Packetization and Encapsulation Signal 60 is fed to the Information Packetization and Encapsulation process 340. The Information Packetization and Encapsulation process 340 embodies encryption, rights management, and packet preparation and segmentation resulting in Information Capsules 350, 355 controlled via the Capsule Signal 70. The number of Information Capsules varies based on the Capsule Signal 70 control. Two capsules are depicted in this exemplary embodiment; however, any number of capsules may be supported.

Information Capsules lead to Distribution Packets 360, 363, 367 triggered via the Distribution Packet Signal 80, 85. The number of Distribution Packets varies based on the Distribution Packets Signal 80, 85 control. Three packets are depicted in this exemplary embodiment; however, any number of packets may be supported.

Distribution Packets 360, 363, 367 feed the Distribution Control Signal and Data Packet Channel 90 leading into the Intelligent State-Based Packet Distribution Control 370. The Cache Signal and Data Packets 100 feeds the Intelligent State-Based Content Caching Control 380. The Intelligent State-Based Content Caching Control 380 sends a feedback signal back to the State-Based Information Access Control module 320 via the Cache Request Signal 120. The Intelligent State-Based Content Caching Control 380 also populates the Intelligent Packet Cache 390 via the Cache Status Signal and Data Packet feed 110.

Display of the cached packets begins in the Intelligent Packet Cache 390 triggered by the Assembly Signal and Data 130. The Assembly Signal and Data 130 feeds the Intelligent State-Based Information Assembly process 400. The Intelligent State-Based Information Assembly process 400 produces a Multiphasic Control Signal with encapsulated data 140 feeding the Multiphasic Experience Control 410. The display process is completed as the Multiphasic Experience Control 410 feeds the Display Signal and Data 150 to the Information Display 420.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

1. A digital content control system, comprising:
a distributed intelligent-assistant control for content packetization and encapsulation;
one or more intelligent state-based caching modules for predictive content distribution;
means for programmatic control of state-based automata for intelligent caching modules;
a flowthrough administrative control; and
one or more multiphasic user experience presentation modules.

2. The system of claim 1, wherein the system comprises a “smart client” architecture.

3. The system of claim 2, wherein the “smart client” architecture maintains closed loop security services for individual “smart client” connections.

4. The system of claim 1, wherein the system enables asynchronous file access.

5. The system of claim 1, wherein the system comprises a “bandwidth multiplexing” architecture or a “latency reduction” architecture.

6. The system of claim 5, wherein transmission efficiencies are enabled via distributed or local intelligent caching or both, and further wherein said transmission efficiencies comprise “bandwidth multiplexing” or “latency reduction” or both.

7. The system of claim 1, wherein the system provides state-based intelligent-assistance for digital content distribution or digital content display control or both.

8. The system of claim 1, wherein the system provides state-based data and control flow for digital information distribution and display.

9. The system of claim 1, further comprising one or more multiphasic display preparation and presentation modules.

10. A digital content control system, comprising:
one or more state-based intelligent caching modules.

11. The system of claim 10, wherein the state-based intelligent caching modules comprise distributed caching storage locations.

12. A digital content control system, comprising:
one or more control signals;
one or more state-based processing and intelligent caching modules;
state-based data and control flow; and
one or more display presentation modules.

13. The system of claim 12, wherein intelligence assistance logic is embedded programmatically within the state-based automata of the state-based processing and intelligent caching modules.

14. The system of claim 12, where the system is adapted to control the multiphasic display of digital content dependent upon a state-based status and intelligent-assistant logic.

15. The system of claim 12, wherein the system programmatically integrates distributed automata theory processing for alternative, yet interrelated, states of control within a digital content display system.

16. The system of claim 12, wherein the system provides for distributed intelligent-assistant control of predictive digital information distribution.

17. The system of claim 12, wherein the system provides for distributed intelligent-assistant control for content packetization and encapsulation.

18. The system of claim 12, wherein the system provides for intelligent state-based caching for predictive content distribution.

19. The system of claim 12, wherein the system provides for programmatic control of state-based automata for intelligent caching modules, and further wherein the system provides for flowthrough administrative control.

20. The system of claim 12, further comprising multiphasic user experience presentation modules.
